(19) United States
(12) Patent Application Publication
(10) Pub. No.: US 2026/0369728 A1
(43) Pub. Date: Nov. 19, 2026

(54) Cooling Plate

(71) Applicant: MAHLE International GmbH, Stuttgart (DE)

(72) Inventors: Eduard REIMER, Fellbach (DE); Alexandra SCHNAARS, Renningen (DE); Dierk HOFFMANN, Leonberg (DE)

(21) Appl. No.: 19/671,403

(22) Filed: May 8, 2026

(30) Foreign Application Priority Data
May 14, 2025 (DE) 102025118487.9

(51) Int. Cl. H01M 10/6554; B60L 50/64; F28F 3/14; F28F 21/06; F28F 21/08; H01M 10/613; H01M 10/625; H01M 10/647; H01M 10/656

(52) U.S. Cl. CPC H01M 10/6554; B60L 50/64; F28F 3/14; F28F 21/065; F28F 21/084; H01M 10/613; H01M 10/625; H01M 10/647; H01M 10/656; F28F 2230/00; H01M 2220/20

(57) ABSTRACT

A cooling plate for a cooling device, in particular for batteries, which has two shells is provided. The cooling plate includes two shells that form a hollow chamber within the cooling plate in which a foam core with an outer envelope is placed, wherein the envelope isolates most of the foam from the hollow chamber and the coolant therein, the envelope for the foam core is made of two plates that are separate from the shells, each plate is bonded to one of the two shells, and the plates are sealed to one another at the edges, such that at least most of the foam core is isolated from the hollow chamber and the coolant therein.

### CROSS-REFERENCE TO RELATED APPLICATIONS

This application claims priority from German Patent Application No. DE 102025118487.9, filed on May 14, 2025, the entirety of which is hereby incorporated by reference herein.

The present invention relates to a cooling plate for batteries as set forth in the preamble of Numbered Paragraph 1. The invention also relates to a battery assembly that contains at least two batteries and at least one such cooling plate. The invention also relates to an electric or hybrid vehicle that has such a battery assembly.

To improve the performance of a vehicle battery, in particular for modern electric or hybrid vehicles, or at least be able to maintain its performance, batteries, usually lithium-ion batteries, are cooled to keep them within an optimal temperature range for charging or outputting electricity. The cooling system for these batteries normally contains cooling plates on the sides of the battery stacks with which the batteries are cooled. These batteries can be more efficiently and evenly cooled with cooling plates placed between the individual batteries.

There is a so-called “breathing” effect when the batteries are subjected to high loads, e.g. during quick charging as well as when the batteries have been partially drained, which relates to expansion and contraction of the batteries. The batteries also become thicker with age, referred to as a “swelling” effect. These effects change the sizes of the batteries, and adjacent batteries must be able to at least partially compensate for this, i.e. they must be able to be compressed, to avoid damaging the batteries or adjacent components.

The compressibility of adjacent components, specifically the cooling plates, is extremely limited, and therefore other components such as foam must be placed between the batteries.

When cooling plates are placed between the batteries, they can be flexible plates that can compensate for the changes in size that the batteries undergo. One option is to integrate foam within these cooling plates that can change size as needed. This foam may come in contact with the coolant. The disadvantage with these foams is that they are usually made of polyurethane and are open-celled, such that they can absorb any coolant they come in contact with. This alters the mechanical properties of the foam (elasticity, resilience, etc.) thus accelerating the aging process, such that they no longer adequately support the batteries.

The problem addressed by the present invention is to therefore create a better, or at least different, design for a cooling plate with which the disadvantages of the prior art are at least partially overcome.

This problem is solved by the subject matter of the independent Numbered Paragraph 1. Advantageous embodiments are the subject matter of the dependent Numbered Paragraphs.

The present invention is based on the general concept of encapsulating a foam core within a cooling plate, thus protecting it against coming in direct contact with coolant, to overcome the aforementioned disadvantages. The cooling plate obtained with the invention for cooling batteries in an electric or hybrid vehicle is composed of two shells with a hollow chamber formed between them that can accommodate a foam core with an outer envelope that protects at least most of the foam from the coolant inside the chamber. This envelope is formed by two plates, which are separate from the shells, each of which is bonded to one of the shells. The plates are sealed against one another at their edges, thus protecting at least most of the foam from coolant inside the chamber, such that its resilience and flexibility does not diminish appreciably over time.

Bonding these plates to the shells makes assembly of the cooling plate relatively simple. First, one of the shells is produced, and a first plate is then placed and secured therein. The foam core is then placed on the plate. A second plate is bonded to a second shell. The edges of both plates are bent or curved. The second shell, with the second plate, is then placed on the first shell, with the first plate, and pressed against it. This presses the edges of the plates against one another to form a seal that protects at least most of the foam from coolant. Different channels and cross sections can be obtained by varying the shapes of the plates placed in the shells forming the cooling plate. By varying the thickness and density of the foam, the properties of the cooling plate can be adapted to the breathing and swelling behaviors of the batteries. The shells are bonded to the plates by brazing, adhesive, or welding. Because the shells and plates are separate elements, they can be easily and inexpensively produced in advance, independently of the cooling plates.

To prevent coolant from coming in contact with the foam at the edges of the plates, they can be bonded to one another directly, i.e. with no foam between their edges, or the foam can be compressed to circa 10-75%, preferably 25-75%, ideally 25-50% of its thickness d_{S} at the edges, thus closing its pores there. In this case, a small part of the foam lying outside the edges would still come in contact with the coolant, while most of the foam never comes in contact therewith because the pores are compressed at the edges to the extent that no coolant can pass between the plates. The plates encasing the foam can be bonded thereto with an adhesive.

The cooling plate obtained with the invention at least reduces, ideally prevents, any undesired changes in the mechanical properties of the foam, or an accelerated aging thereof, indirectly impacting the support of the individual batteries, such that the elasticity of the cooling plate is maintained for a longer period of time. This elasticity ensures that the cooling plate remains in contact with the batteries for reliable and effective heat exchange.

Reference is always made to cooling plates and coolant in this patent application, although it is understood that these cooling plates can also be used to heat batteries with warm coolant.

A seal can also be placed between the plates at their edges. This seal can also be used to hold the edges together, resulting in a complete encapsulation of the foam, protecting it against any contact with coolant inside the hollow chamber formed within the cooling plate. This seal is not only inexpensive, it is easy to install, resulting in a comparatively simple and inexpensive seal on the edges of the envelope.

The seal is ideally formed by a separate O-ring, adhesive bead, or sealing compound. This inconclusive list is an indication of the many possibilities for obtaining such a seal. By way of example, an O-ring, i.e. a rectangular seal with a round cross section, can be placed between the plates and compressed there, thus preventing the foam within the envelope from coming in contact with the coolant.

The envelope can be made of plastic, in particular an elastomer. In this case, the foam core can be encompassed in a plastic frame or envelope made of plastic, which also reliably protects the foam from coolant in the chamber formed within the cooling plate. By using an elastomer for the envelope, it is ensured that it will remain flexible over a long period of time, such that it can compensate for any breathing effects exhibited by the adjacent batteries. The plates could also be made of metal, in particular aluminum.

The shells are ideally made of aluminum. Aluminum has a high thermal conductivity coefficient, and can therefore transfer heat effectively, making it ideal for use in these cooling plates. Aluminum also has a comparatively low density, resulting in a lighter cooling plate, which has advantages when used in electric and hybrid vehicles.

The thickness d_{P} of the plates can be circa 0.1 mm to 0.5 mm, preferably 0.3 mm. This is sufficient for protecting the foam therein from coolant, while still obtaining lighter plates and reducing consumption of resources.

The foam core in the cooling plate obtained with the invention is preferably made of polyurethane. Polyurethane is extremely durable and has a high tensile strength, as well as remaining flexible even in cold temperature, does not break down when exposed to oil or grease, and also remains stable at higher temperatures. Polyurethane is also relatively inexpensive, such that the costs for producing such a cooling plate can be kept low.

The present invention also relates to a battery assembly that contains at least two batteries and at least one cooling plate, as described above, which is then placed between the two batteries. Consequently, the advantages obtained with the cooling plate also apply to the battery assembly obtained with the invention. In concrete terms, these advantages include a reduction in the number of components between the batteries, and protecting a foam core from coolant, eliminating any negative effects thereof, e.g. acceleration of the aging process, such that the battery assembly obtained with the invention is significantly less expensive and has a longer service life.

Ideally, the cooling plate in the battery assembly obtained with the invention is directly or indirectly bonded by an adhesive layer to at least one of the batteries. This adhesive layer is not only less expensive and a better thermal conductor than the thicker thermal interface materials used in the prior art, but it also allows the cooling plate to resume its former size and shape when the batteries shrink back to their original sizes. The adhesive layer is much thinner than the previously used thermal interface materials, resulting in a battery assembly that is not only less expansive, but also lighter. This also makes it possible to place more batteries within the same space, resulting in higher performance.

The present invention also relates to an electric or hybrid vehicle that has such a battery assembly, and therefore has the same advantages as those obtained therewith. In concrete terms, these include a less expensive production of the battery assembly through the elimination of the more expensive thermal interface materials and a higher battery capacity, because the space occupied by these thicker thermal interface materials can be used for batteries, because the cooling plate obtained with the invention can be compressed, such that it can compensate for breathing and swelling effects. Furthermore, the negative effects coolant has on the foam, such as accelerated aging, can be prevented, thus increasing the service life of the cooling plate.

Other important features and advantages of the invention can be derived from the dependent Numbered Paragraphs, drawings, and descriptions of the drawings.

It is understood that the features specified above and described below can be used not only in the given combinations, but also in other combinations or in and of themselves, without abandoning the scope of protection for the present invention. Components of a higher-order unit, e.g. an element, device, or assembly, specified above or below, which are indicated separately, can form separate components of this unit, or be integral parts thereof, even if otherwise indicated in the drawings.

Preferred exemplary embodiments of the invention are shown in the drawings and shall be explained in greater detail below, in which the same reference symbols are used for the same, similar, or functionally identical components.

Therein, schematically,

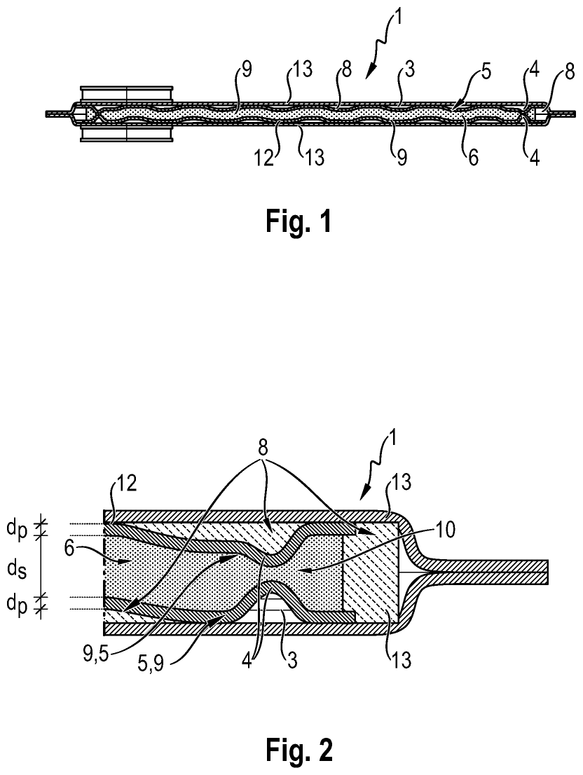

FIG. 1 shows a sectional view through a cooling plate obtained with the invention,

FIG. 2 shows a detail from FIG. 1,

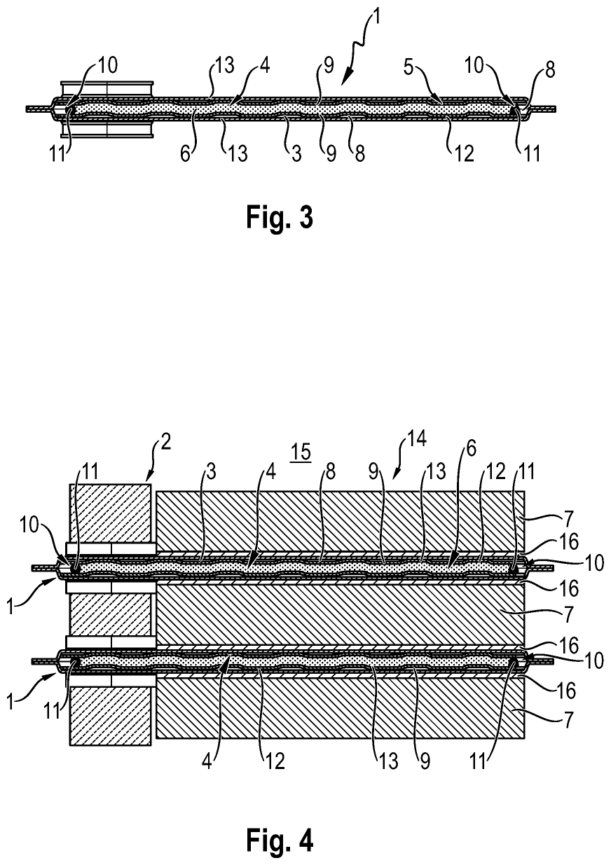

FIG. 3 shows a sectional view like that in FIG. 1, in which the plates forming the envelope are sealed with a seal, and

FIG. 4 shows a battery assembly obtained with the invention, for an electric or hybrid vehicle obtained with the invention, containing a cooling plate obtained with the invention.

As FIGS. 1-4 show, the cooling plate 1 obtained with the invention, for a cooling device 2 (see FIG. 4) for batteries, has two shells 13 forming a hollow chamber 3 in the cooling plate 1, in which a foam core 6 with an envelope 5 is placed, wherein the envelope 5 isolates at least most of the foam 6 from the chamber 3 and the coolant 8 therein. The envelope 5 for the foam core 6 is made of two plates 9 that are separate from the shells 13, each of which is bonded to one of the two shells 13. The plates 9 are sealed to one another at the edges 10 and compress the foam 6 sufficiently to form a seal there, such that at least most of the foam 6 is isolated from the chamber 3 and the coolant 8 therein. The foam 6 allows the cooling plate 1 to expand or contract in response to expansion or contraction of the batteries 7 caused by the breathing effects (see FIG. 4), such that it always remains in contact with the batteries 7. By isolating the foam 6, which can be made of polyurethane, from the coolant 8, negative effects the coolant 8 may have on the foam 6, such as accelerated aging, or a reduction in its mechanical properties, e.g. elasticity, can be prevented.

If the foam 6 is not isolated from the coolant 8, the open-cell foam 6 absorbs coolant 8 over time, having a negative impact on the mechanical properties thereof, such as its elasticity and resilience, and the foam 6 will eventually break down and no longer adequately support the batteries 7, such that they age more quickly.

These disadvantages can be resolved with the cooling plate 1 obtained with the invention, and the foam core 6 encapsulated therein.

The cooling plate 1 can be assembled comparatively easily with the plates 9 connected to the shells 13. A first shell 13 is produced, and a first plate is then placed and secured therein. The foam core 6 is then placed on this plate 9. A second plate 9 is then bonded to a second shell 13 for the cooling plate 1. Both plates 9 have an edge 10 that is bent or curved 4 (see FIG. 2). The second shell 13 with the second plate 9 is then placed on the first shell 13 with the first plate 9 and the foam core 6, and pressed against it. This presses the bent parts 4 against one another to from a seal, which then protects the foam core 6 between the two plates 9 against direct contact with the coolant 8. The shells 13 are attached to the plates 9 by brazing, adhesive, or welding. By producing the plates 9 separately from the shells 13, they can also be produced in advance easily, inexpensively, and independently from the cooling plate 1.

FIGS. 1 and 2 also show that the foam core 6 is compressed to circa 10-75%, preferably 25-75%, ideally 25-50% of its thickness d_{S} at the edges 10 between the bent parts 4, thus closing its open-cell structure. This prevents coolant 8 from entering the foam core 6, or at least makes it more difficult.

The foam 6 to the right of the edge 10 in FIG. 2 is in direct contact with the coolant 8, but the foam is compressed enough at the edges 10 that its pores are closed there, such that it is difficult, if not entirely impossible, for any coolant 8 to pass through. To the left of the edge 10, the foam is encapsulated and thus isolated from any coolant 8 in the hollow chamber 3, thus preventing the aforementioned negative impacts on the aging and elasticity of the foam 6.

A seal 11 can also be placed on the edges 10 between the two plates 9 forming the envelope 5 (see FIGS. 3 and 4), which can be formed by a separate O-ring, adhesive bead, or sealing compound. This seal 11 can protect the entire foam core 6 from coming in direct contact with the coolant 8.

The shells 13 forming the cooling plate 1, and/or the plates 9 forming the envelope 5 can be made of aluminum, resulting in a lower weight and greater thermal conductivity. The plates 9 typically have a thickness d_{P} of circa 0.1 mm to 0.5 mm, preferably 0.3 mm. This results in an envelope 5 and foam core 6 that can withstand compression for a very long time.

The foam core 6, which can be made of polyurethane, has a thickness d_{S} of circa 2 mm, which can therefore be compressed sufficiently to compensate for the breathing and swelling effects of the batteries 7.

The envelope 5 can also be made of plastic, forming a type of frame, in particular made of an elastomer. This results in a comparatively inexpensive, light, and easily produced envelope 5 for the foam core 6.

To be able to reliably secure the plates 9 in the cooling plate 1, the plates 9 can be bonded at predefined points 12 to an inner surface of the shells 13 forming the cooling plate 1, e.g. with an adhesive, brazing, or welding.

The cooling plate 1 is used in a cooling device 2 for a battery assembly 14 obtained with the invention (see FIG. 4), which can be used in an electric or hybrid vehicle 15, and contains at least two, preferably prismatic, batteries 7, and at least one cooling plate 1 obtained with the invention placed between these two batteries 7.

The cooling plate 1 can be attached to the adjacent batteries 7 directly, or indirectly with an adhesive layer 16, which is not only significantly thinner, but also less expensive and more thermally conductive than the terminal interface materials used in the prior art.

The specification can be readily understood with reference to the following numbered Paragraphs:
Numbered Paragraph 1. A cooling plate (1) for a cooling device (2), in particular for batteries, which has two shells (13), characterized in that
   the two shells (13) form a hollow chamber (3) within the cooling plate (1) in which a foam core (6) with an outer envelope (5) is placed, wherein the envelope (5) isolates most of the foam (6) from the hollow chamber (3) and the coolant (8) therein,
   the envelope (5) for the foam core (6) is made of two plates (9) that are separate from the shells (13),
   each plate (9) is bonded to one of the two shells (13),
   the plates (9) are sealed to one another at the edges (10), such that at least most of the foam core (6) is isolated from the hollow chamber (3) and the coolant (8) therein.
Numbered Paragraph 2. The cooling plate (1) according to Numbered Paragraph 1, characterized in that the plates (9) have a bend (4) at the edges (10) where they are pressed together.
Numbered Paragraph 3. The cooling plate (1) according to Numbered Paragraph 2, characterized in that the foam (6) is compressed between the two bends (4) in the plates (9) at the edges (10) to 10-75%, preferably 25-75%, ideally 25-75% of its thickness d_{S}, thus closing its pores.
Numbered Paragraph 4. The cooling plate (1) according to any of the preceding Numbered Paragraphs, characterized in that a seal (11) is placed between the plates (9) at the edges (10).
Numbered Paragraph 5. The cooling plate (1) according to Numbered Paragraph 4, characterized in that the seal (11) is a separate O-ring, adhesive bead, or sealing compound.
Numbered Paragraph 6. The cooling plate (1) according to any of the preceding Numbered Paragraphs, characterized in that the plates (9) are made of plastic, in particular an elastomer, or metal, in particular aluminum.
Numbered Paragraph 7. The cooling plate (1) according to any of the preceding Numbered Paragraphs, characterized in that the two shells (13) are made of aluminum.
Numbered Paragraph 8. The cooling plate (1) according to any of the preceding Numbered Paragraphs, characterized in that the plates (9) have a thickness d_{P} of 0.1 mm to 0.5 mm, preferably 0.3 mm.
Numbered Paragraph 9. The cooling plate (1) according to any of the preceding Numbered Paragraphs, characterized in that the foam core (6) is made of polyurethane, and/or has a thickness d_{S} of circa 2.0 mm.
Numbered Paragraph 10. A battery assembly (14) that contains at least two, preferably prismatic, batteries (7), and at least one cooling plate (1) according to any of the preceding Numbered Paragraphs, which is placed between the two batteries (7) and is bonded thereto for heat exchange.
Numbered Paragraph 11. The battery assembly (14) according to Numbered Paragraph 10, characterized in that the cooling plate (1) is connected directly or indirectly, by an adhesive layer (16), to at least one battery (7).
Numbered Paragraph 12. An electric or hybrid vehicle (15) that has a battery assembly (14) according to Numbered Paragraph 10 or 11.

### LIST OF REFERENCE SYMBOLS

1 cooling plate
2 cooling device
3 hollow chamber
4 bend/curve
5 envelope
6 foam core
7 battery
8 coolant
9 plate
10 edge
11 seal
12 point
13 shell
14 battery assembly
15 electric or hybrid vehicle
16 adhesive layer
17 outer shell
18 outer shell

1-12. (canceled)

13. A cooling plate for a cooling device, in particular for batteries, comprising:
two shells, wherein the two shells form a hollow chamber within the cooling plate in which a foam core with an outer envelope is placed, wherein the envelope isolates most of the foam from the hollow chamber and the coolant therein,
wherein the envelope for the foam core is formed from two plates that are separate from the two shells, wherein each plate is bonded to one of the two shells, and
wherein the two plates are sealed to one another at the edges, such that at least most of the foam core is isolated from the hollow chamber and the coolant therein.

14. The cooling plate according to claim 13, wherein the two plates each have a bend at the edges where the two plates are pressed together.

15. The cooling plate according to claim 14, wherein the foam core is compressed between the two bends in the two plates at the edges to 10-75% of its thickness d_{S}, thus closing its pores.

16. The cooling plate according to claim 13, wherein a seal is disposed between the two plates at the edges.

17. The cooling plate according to claim 16, wherein the seal is an O-ring, adhesive bead, or sealing compound.

18. The cooling plate according to claim 13, wherein the two plates are formed from of an elastomer or aluminum.

19. The cooling plate according to claim 13, wherein the two shells are formed of aluminum.

20. The cooling plate according to claim 13, wherein the two plates have a thickness d_{P} of 0.1 mm to 0.5 mm, preferably 0.3 mm.

21. The cooling plate according to claim 13, wherein the foam core is made of polyurethane, and/or has a thickness d_{S} of about 2.0 mm.

22. A battery assembly comprising at least two batteries, and at least one cooling plate according to claim 13, wherein the cooling plate is placed between the at least two batteries and is bonded to the at least two batteries for heat exchange.

23. The battery assembly of claim 22, wherein the at least two batteries are prismatic.

24. The battery assembly according to claim 22, wherein the cooling plate is connected directly or indirectly, by an adhesive layer, to at least one battery.

25. An electric or hybrid vehicle, comprising a battery assembly according to claim 22.

26. The electric or hybrid vehicle of claim 25, wherein the cooling plate is connected directly or indirectly, by an adhesive layer, to at least one battery.

27. The cooling plate according to claim 15, wherein the foam core is compressed between the two bends in the two plates at the edges to 25-75% of its thickness d_{S}.

28. The cooling plate according to claim 27, wherein the foam core is compressed between the two bends in the two plates at the edges to 25-50% of its thickness dS.

29. The cooling plate according to claim 20, wherein the two plates have a thickness dP of 0.3 mm.
